(19) United States
(12) Patent Application Publication
(10) Pub. No.: US 2004/0210330 A1
(43) Pub. Date: Oct. 21, 2004

(54) Control method and industrial production installation with web control system

(75) Inventor: Fritz Birkle, Mindelheim/Nassenbeuren (DE)

Correspondence Address: McGLEW AND TUTTLE, John James McGlew, Scarborough Station, Scarborough, NY, 10510-0827, US

(73) Assignee: KUKA SCHWEISSANLAGEN GMBH

(21) Appl. No.: 10/839,893

(22) Filed: May 6, 2004

Related U.S. Application Data
(63) Continuation of application No. 10/220,744, filed on Sep. 4, 2002, now abandoned.
Application No. 10/220,744 is a 371 of international application No. PCT/EP01/02653, filed on Mar. 9, 2001.

(30) Foreign Application Priority Data
Mar. 10, 2000 (DE) 200 04 370.6

(51) Int. Cl. G06F 19/00

(52) U.S. Cl. 700/96; 700/117

(57) ABSTRACT

A control method and to an industrial production installation (1) is provided, especially for manufacturing parts of unfinished vehicle bodies. The production installation (1) has one or more intelligent application components (3), especially multiple-axle robots (4), welding, gluing or chucking installations or comparable treatment installations, and at least one installation control (10). The installation control (10) controls the intelligent application components (3) by a web control system (2) by a Fast Ethernet data network (16). The intelligent application components (3) are provided with a respective web server (13) with at least one individual homepage (17) according to internet standard. Web control can also take place within the application components (3), the control elements (25) and the associated device elements (26) of the intelligent application components being interlinked via a web control system (2) and a Fast Ethernet data network (16). The device elements (26) are provided with an intelligence (12) or with an intelligent interface (24) of their own and each with a web server (13) with at least one individual homepage (17).

### CROSS REFERENCE TO RELATED APPLICATIONS

This is a Continuation of application Ser. No. 10/220,744 filed Sep. 4, 2002, and the entire disclosure of this prior application is considered to be part of the disclosure of the accompanying application and is hereby incorporated by reference herein.

### FIELD OF THE INVENTION

The present invention pertains to a control process and an industrial production system, especially for the manufacture of components of vehicle bodies, with the production system having one or more said intelligent application components, especially multiaxial robots, welding, bonding or clamping means or the like, and at least one system control, which is equipped with a WEB server with at least one homepage of its own according to the Internet standard.

### BACKGROUND OF THE INVENTION

Such a control process and an industrial production system have been known from EP-A 0 825 506. The production system has a system control in the form of a so-called Server Digital Data Processor and a plurality of application components. The system control is designed as a programmable logic control (PLC) and is connected to input devices and display devices via a network. The system control and the input and display devices are equipped with Internet WEB browsers, the communication in this network taking place according to Internet standards under the Transmission Control Protocol/Internet Protocol (TCP/IP protocol). However, only information and programs are exchanged. The network is limited to the system control and the input and display devices. The application components are controlled by the system control in the conventional manner with a proprietary bus system. A special control program is to be prepared for each application. Special applications, such as spot welding, bonding, stud welding, etc., are controlled with special application controls. Special software programs are likewise prepared and used for this. Proprietary bus systems are likewise used for the information exchange with the sensors and actuators as well as between the individual controls of the application components. The prior-art production system requires a great effort for designing, construction, building and putting into operation. The intelligent system components, being proprietary and noncompatible systems, are very expensive. Special hardware and software are to be designed, constructed, built and put into operation for each production system and for each application. Moreover, information can be made available from the component level to the system level at a very great effort only. The operator of a production system must, moreover, be familiarized with the corresponding controls and operating and observation devices.

### SUMMARY OF THE INVENTION

The object of the present invention is to improve such an industrial production system.

According to the invention, a process is provided for controlling an industrial production system, especially for manufacturing components of vehicle bodies, comprising one or more intelligent application components, especially multiaxial robots, welding, bonding or clamping means or the like, and at least one system control, which is equipped with a WEB server with at least one homepage of its own according to the Internet standard. The system control controls the intelligent application components by a WEB control system and a data network, wherein the intelligent application components are equipped with a WEB server each with at least one homepage of its own according to the Internet standard.

The use of a WEB control system between the system control and the intelligent application components instead of the current proprietary bus systems has the advantage that the effort on the hardware and software side for designing, constructing, building and putting into operation the production system is substantially reduced. The costs are correspondingly lower. Internet-compatible techniques, which originate from the office world and are available in a wide selection at low cost, are used in the hardware and software for the WEB control system. The techniques meet the widespread Internet standards. They are compatible with one another and are open as a general standard. They are tested and have a high reliability in operation.

The system control can control the intelligent application components in real time via the WEB control system. Control commands, feedback and other similar information necessary for a direct control are exchanged between the application control and the application components. In addition, status messages, information on devices, programs, etc., can be transmitted.

Not only is the design and programming effort substantially reduced due to such a standardization as a result of the elimination of the proprietary systems. The operation and the maintenance by the user of the system is also simplified and facilitated. A uniform user/system interface also has a favorable effect. The system users and the employees are frequently already familiar with browsers and homepages. This technique, known and standard from the use of the Internet, facilitates the use of the production system. Changeovers to new systems or changes in existing production systems also become easier due to the standardization.

The WEB control system has the special advantage that via homepages, it makes possible the observation and the diagnosis of all connected intelligent system components at each WEB server equipped with a suitable display and also at each possibly existing, separate display and operating device in the system. Moreover, via a connection to a system network of the same type or to other connected data networks of the same type, observation and diagnosis may also take place at any desired and suitable point in these networks. Moreover, operation and control of the individual intelligent system components may also be performed, in principle, by any display and operating device in the WEB control system and in other connected data networks of the same type. However, this may be limited for other reasons, e.g., because of safety engineering requirements. These potential possibilities of intervention include a very great variety of forms of influencing, e.g., manual control, reprogramming, the rerecording or exchange of programs, the modification of parameters, etc.

A WEB control system may exist not only between the system control or system controls and the individual control parts of the intelligent application components. Such a WEB control system may also be present within the intelligent application components, in which case the control parts control the device parts of the application components, which device parts are likewise equipped with suitable intelligences, in the above-described manner. The WEB control system existing at the system level with its data network and the WEB control system existing within the individual system components with corresponding data network (Fast Ethernet lines) may be linked with one another. The transparency and the control possibilities of the production system are increased even further as a result.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a production system with a plurality of intelligent system components;

FIG. 2 is a homepage of the production system and the intelligent system components;

FIG. 3 is a figure of the control architecture of the WEB control system;

FIG. 4 is a structural view of the homepage;

FIG. 5 is a WEB control system with sequence control and tool with embedded chip;

FIG. 6 is a variant of FIG. 5 with intelligent interface; and

FIG. 7 is a side view of a part of the production system according to FIG. 1.

### DESCRIPTION OF THE PREFERRED EMBODIMENTS

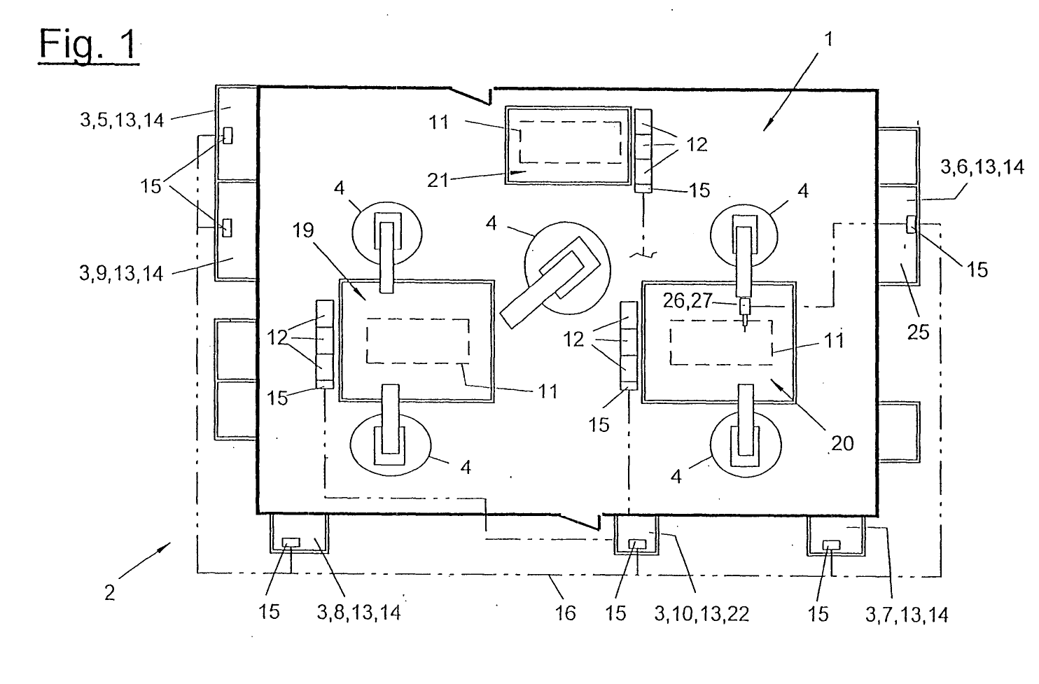

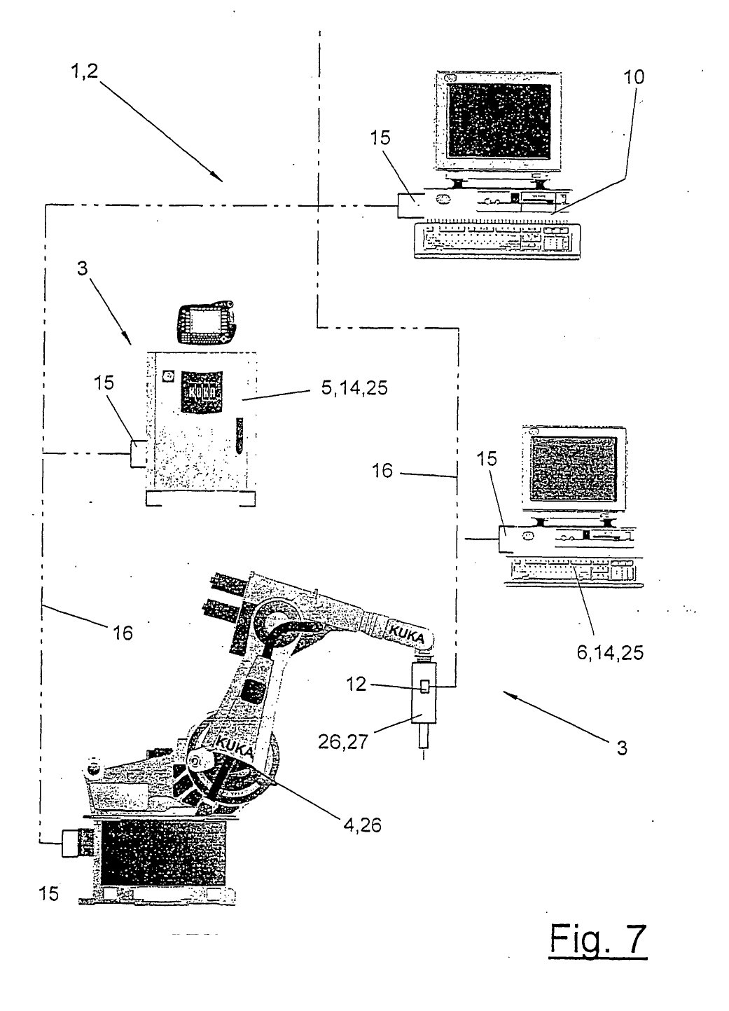

Referring to the drawings in particular, FIGS. 1 and 7 schematically show an industrial production system 1. It is preferably used in the automobile industry and is used to manufacture components of vehicle bodies. The components are not shown for clarity's sake. The production system 1 is designed as a production cell in this exemplary embodiment being shown, but it may also have any other form and design. Three processing areas 19, 20, 21 for the components are arranged in the production system 1, and the components are fed in via a place of deposit for components (not shown) and removed after the processing. Moreover, additional and other transfer sites may be present for components, tools and other elements.

Any process, e.g., handling and processing operations, may take place in the production system 1. The processing may likewise be of any desired nature, e.g., spot welding, inert-gas shielded arc-welding, bonding, assembly, machining, etc.

The production system 1 has at least one system control 10 and a plurality of intelligent application components 3, which are designed as processing devices. The intelligent application components 3 are controlled by the system control 10 with a WEB control system 2 and are connected to one another by a data network 16.

The WEB control system 2 comprises a plurality of WEB servers 13 associated with the intelligent application components 3 with at least one homepage 17 each belonging to them and with at least one interface 15 each for the connection to the data network 16. Each intelligent system component 3 preferably has a WEB server 13 of its own with at least one homepage 17 of its own. Suitable display and operating devices 22 may be associated with the WEB servers 13. As an alternative or in addition, one or more separate display and operating devices 22 may be present and connected to the data network 16.

The display and operating devices 22 and the WEB servers 13 are equipped with a suitable communications software. In particular, WEB browsers for displaying and operating the corresponding homepages 17 are installed on the display and operating devices 22. The data network 16 is preferably designed as a Fast Ethernet (gigabit Ethernet) data network using the TCP/IP protocol. The interfaces 15 are also designed correspondingly and are designed, e.g., as Fast Ethernet plug cards. The above-mentioned components correspond to the common Internet standards in terms of software and hardware. In case of a change in the Internet standards, a corresponding adaptation of the components may be performed.

The intelligent application components 3 comprise a control part 25 and a device part 26 each. At least one system control 10, which comprises an industrial PC with a software-based sequence control running on it, is present for the control of the entire production system 1. At least one application or sequence program is running on the sequence control. At least the system control 10 preferably also has a display and operating device 22. The system control 10 preferably controls all intelligent application components 3 present via the common Fast Ethernet data network 16. The control takes place in application-related real time.

The WEB servers 13 have a separate IP address each and can be accessed directly. Bridges and routers, with which the entire data network 16 can be segmented into smaller deterministic data networks, may be integrated in the data network 16. Moreover, the routers control the data traffic while setting priorities and give priority to the time-critical control data before other data. As a result, a very rapid and purposeful exchange of the control data can be achieved. The control data being exchanged during the control operations consist of, e.g., control commands of the control units 10, 14, 25 and feedback of the accessed receivers. These may be, e.g., acknowledgments of receipt, and a so-called handshake may also be performed to check and secure the data traffic. In addition, the receivers report the performance of the control commands back to the control units 10, 14, 25, which is likewise monitored with a handshake. Furthermore, diagnosis data, programs or other data may be exchanged as well.

Moreover, special software modules, which are based on the TCP/IP protocol and ensure the exchange of the control data in application-related real time by ordering and optionally tightening up the control data in a suitable manner and grouping them in suitable data packages in order to expedite the normally not very fast data traffic under the TCP/IP protocol, are implemented in the WEB servers 13.

The intelligent application components 3 in the production system 1 being shown may be designed as various and any processing means. In the embodiment being shown, they comprise, on the one hand, a plurality of multiaxial robots 4 along with at least one robot control 5, which handle and/or process, e.g., grasp, transport, clamp, fit, weld, bond, etc., the components by means of suitable tools 27. For example, a welding tool 27 is shown schematically in FIGS. 1 and 7.

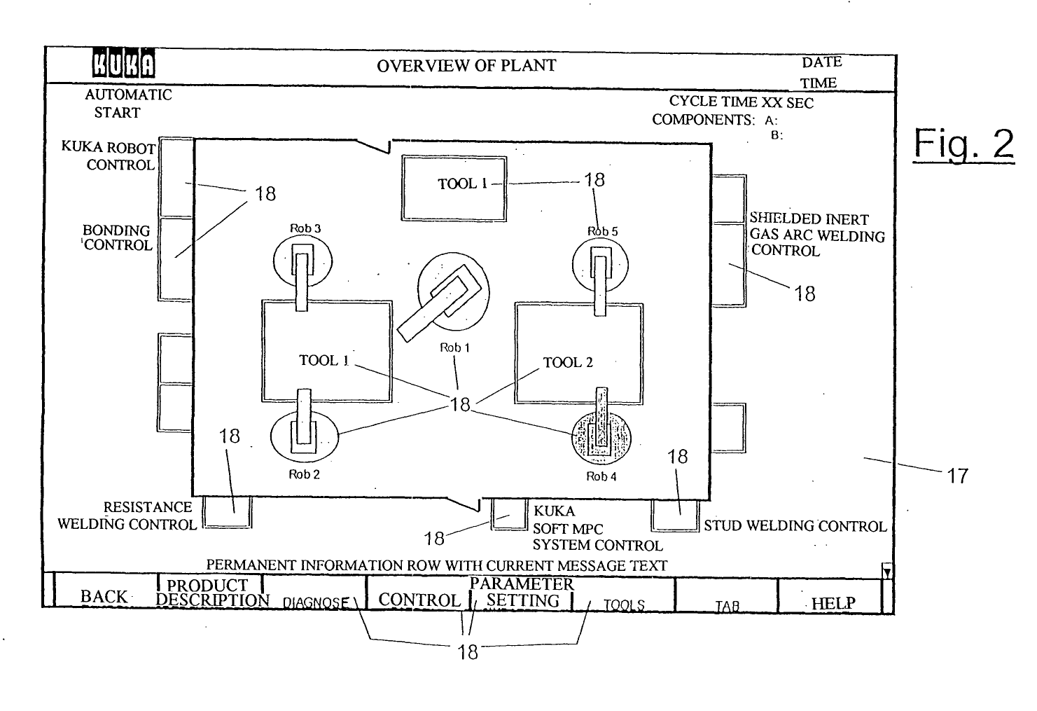

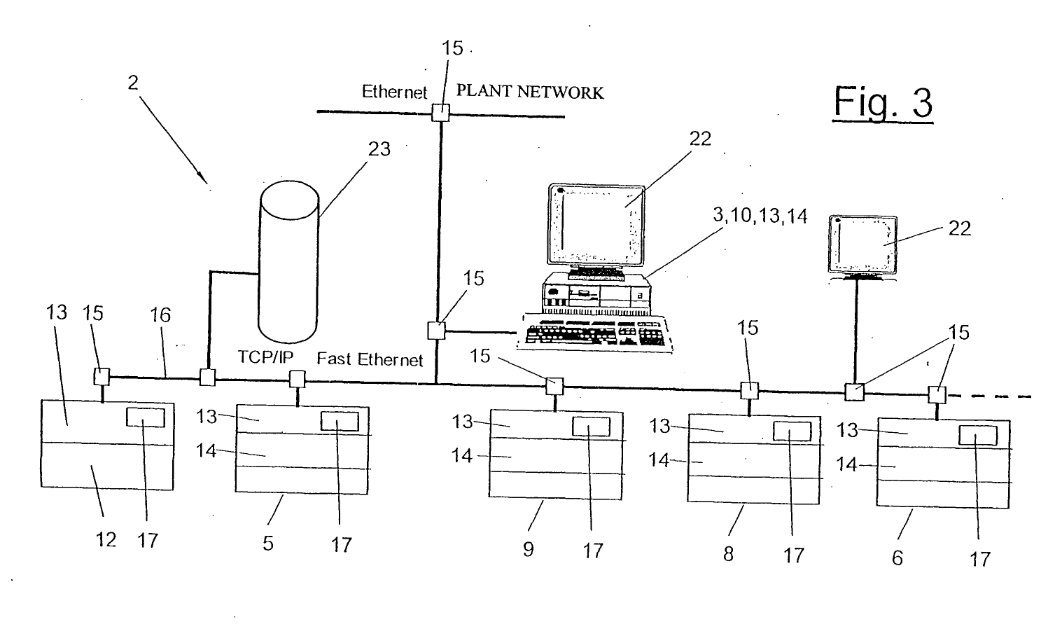

The intelligent application components 3 comprise additional processing means, which comprise robot-guided or stationarily arranged device parts 26 or application tools and corresponding process controls 25, 14. An inert-gas shielded arc-welding control 6, a resistance welding control 8, a stud welding control 7 and a bonding control 9 are shown for this purpose in FIGS. 1 and 2. The application components 3 comprise, furthermore, suitable supply means for operating materials, e.g., a feed means for welding wire, protective gas, welding current, etc.

The intelligent application components 3 include, furthermore, the workpiece seats present at each processing area 19, 20, 21 and tools 11 for the seats, especially clamping tools. They are, e.g., directly connected to the system control 10. The system control 10 may be the only and directly acting control component 25 for these tools 11. The system control 10 forms the control part 25 and the tool 11 the device part 26 of the intelligent application component 3.

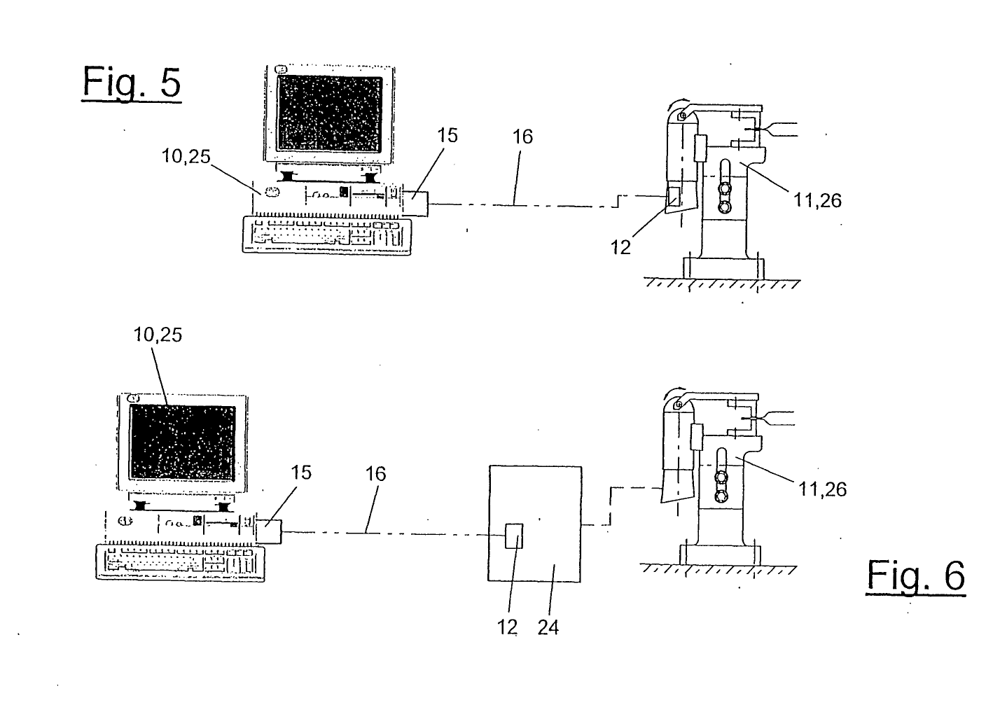

In a first embodiment, which is shown in FIG. 5, the tools 11, here clamps, are provided with a limited intelligence 12, e.g., a so-called embedded chip. The functions of this embedded chip will be specifically described below. In the variant according to FIG. 6, the tool 11 is connected to an interface 24, which has a suitable intelligence 12, e.g., an embedded chip. A plurality of tools 11 may also have a common interface 24. In an alternative, which is not shown here, the tools 11 may also have a more comprehensive intelligence 12 or control of their own in a higher-quality design.

Moreover, a system server 23 may be connected to the data network 16 via an interface 15. The control parts 25 of the intelligent application components 3 have at least one computer 14 each, which is preferably designed as a personal computer, especially an industrial PC, or, in a simpler design, as a microprocessor. The computers 14 may have suitable, directly connected input and output devices 22, so-called human-machine-interfaces (HMI). These are, e.g., a keyboard, a mouse, a marker pen, and suitable display devices, which are preferably designed as screens with graphics capability, e.g., as touch screens.

In the exemplary embodiment being shown, the system control 10 has a PC of its own. In a variant, not shown, the system control 10 may also be designed as a software-based sequence control, which runs on another intelligent application component 3, i.e., the robot control 5. The display and operating device 22 of the intelligent application component 3 may also be used for the system control 10 in this case. A conventional PLC system control with a suitable adaptation or expansion for the integration of a WEB server 13 may be used in another variant.

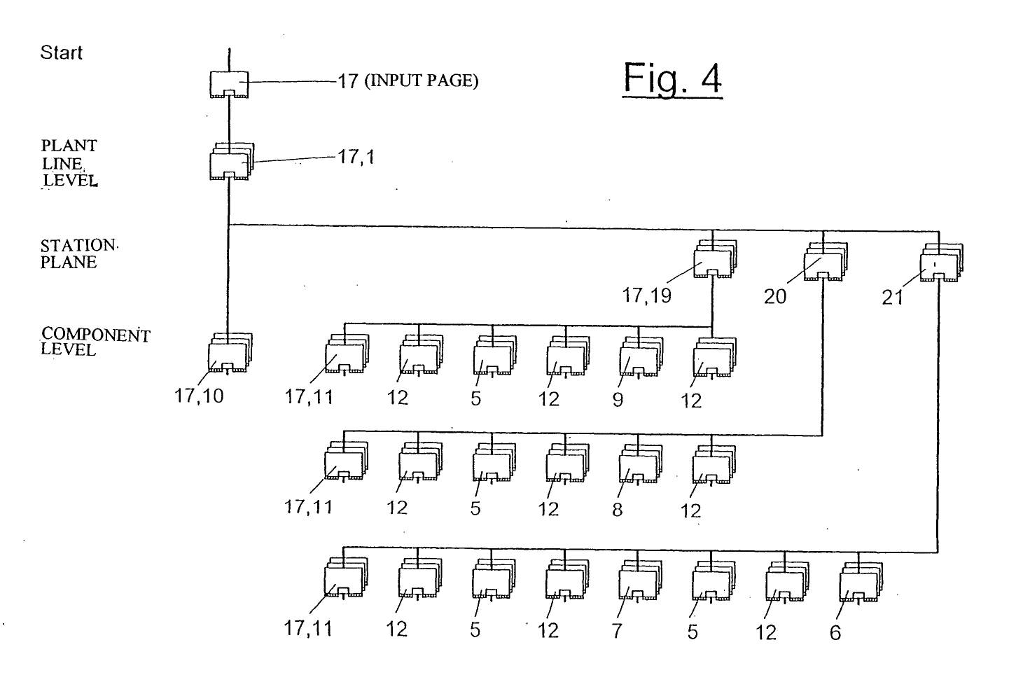

The intelligent application components 3 or their control parts 25 or computers 14 contain the aforementioned WEB server 13 with server and client function and with at least one homepage 17 belonging to the application component 3 with one or more dynamic fields 18 or buttons with links. A plurality of additional, hierarchically structured homepages may be subordinated to the homepage 17. The display and operating devices 22 and especially the additional devices may have a pure client function. They are equipped with a browser for displaying HTML or XML homepages. FIG. 2 shows the homepage 17 of the production system 1, which is preferably common to all WEB servers 13. The separate homepages 17 of the respective intelligent system components 3 can be reached via the links 18 and scroll there further in the subordinate homepages. FIG. 4 shows an exemplary architecture of the homepages 17.

The various intelligent application components 3 preferably have a separate WEB server 13 each. The WEB servers 13 and the computers 14 belonging to them are preferably equipped with such a large memory that they are able to internally store and manage at least their first own homepage 17 and the possibly subordinated homepages. As an alternative, the subordinate homepages 17 may also be stored on other WEB servers 13 in the case of simple computers 14, which comprise only a microprocessor control with a limited internal memory.

The control parts 25 or computers 14 of the intelligent application components 3 with their corresponding device parts 26 or tools 11, 27, e.g., actuators, sensors or the like may also be connected via Fast Ethernet lines and corresponding interfaces for the signal exchange in terms of control engineering. Thus, there also is a WEB control system with data network between the control parts 25 and the device parts 26.

FIG. 7 shows this, e.g., on the basis of a welding device 27 with a corresponding intelligence 12 on the hand of the robot 4 and the inert-gas shielded arc-welding control 6, which is in turn connected via a data network 16 with Fast Ethernet fine and which is in turn connected to the system control 10 via the WEB control system 2 in terms of control engineering in the above-described manner. Likewise, the robot 4 or its individual components represent an intelligent device part 26, which is connected to the corresponding control part 25, namely, the robot control 5, in terms of control engineering in the above-mentioned manner. The device parts 26 now likewise have a WEB server 13 with a separate homepage in their intelligences 12, e.g., embedded chips. The data networks and WEB control systems existing within the intelligent application components 3 may be networked with the higher-level data network 16 and WEB control system 2 or be integrated within same.

The system control 10 is connected to the aforementioned tools 11 via the Fast Ethernet network 16. If the tools 11 are equipped with an intelligence 12, especially an embedded chip, at least the first homepage 17 of the tools 11 may be stored on its WEB server 13, depending on the storage location. The remaining homepages are now stored, e.g., on the WEB server 13 of the system control 10. The interface 15 of the tool 11 or the interface 24 may be provided with an additional intelligence, which functions as a converter, which converts the bit signals of the tools 11 into the TCP/IP protocol of the Fast Ethernet network 16 and vice versa. The above-described device parts 26, e.g., tools 27, robot parts, etc., of the other intelligent applicant components 3 may also be equipped and designed in a corresponding manner.

The WEB control system 2 with the connected WEB servers 13 of the intelligent application components 3 makes possible the display of the operating states of the individual application components 3 and their operation in the “manual” mode. In addition, an automatic control of the intelligent application components 3, which is performed by the system control 10, is also possible via the WEB control system 2 and the data network 16.

The manual influencing and especially control of the intelligent system components 3 among each other takes place via the homepages 17 and their links 18. The homepage 17 of any other intelligent applicant component 3 can be accessed and the state of the component there can be observed from the homepage 17 on the display and operating device 22, e.g., a PC display screen, of the intelligent application components 3.

The production system 1 may be operated and controlled manually, in principle, from any homepage 17 on the WEB server 13. However, this possibility of operation and control may be limited for safety reasons or for other reasons by, e.g., this being possible only from the WEB servers 13 from the location of which there is an undisturbed visual connection to the system component 3 being operated or controlled.

As is illustrated in FIG. 2, a homepage 17 has a plurality of standardized basic components and functions, which are represented, e.g., by means of dynamic fields in the lower horizontal image row. Functions and links for diagnosis, for control, for parameter settings, for a product description, for operating and programming tools, for help and for a jump back to the previous homepage are triggered by these dynamic fields 18. In addition, additional fields may be present.

The control program of the individual intelligent application components 3 runs on the respective control computer 14 belonging to it. The WEB server 13 converts the operating and control signals received from the system control 10 via the Fast Ethernet network 16 into signals which are processed by the control computer 14 and its control program. Individual or general drivers, which are stored on the WEB servers 13 of the individual intelligent system components 3 and/or in the system control 10 or its WEB server 13, may be present for this purpose. The internal control of the intelligent device parts 26 of the system components 3 also functions analogously by means of its control parts 25 or computers 14.

The manual operation of the individual intelligent system components 3 may sometimes take place only via the intermediary of the system control 10. This is true especially when the production system 1 is running in automatic operation and a manual intervention must be coordinated with the function of the system and with the function of the other components 3 of the system. Such a coordination may sometimes also be necessary in manual operation in order to prevent collisions or the like.

The operation, control and programming or parametrization of the intelligent application components 3 via the homepages 17 may take place in various manners and to a varying extent. For example, an application component 3 may be switched on and off by means of corresponding buttons and dynamic fields 18 in the homepage 17. Furthermore, programs, parameters, modes of operation or the like can be selected and modified or set. Movement processes, functions, etc., may now be modified, complemented or newly generated. A movement of the individual axes may take place by manual operation in the case of the robots 4.

The same influencing of the intelligent application components 3 is possible in the preferred embodiment by means of the WEB control system 2 by remote control as can also be performed on the respective corresponding control on the site and directly. The precondition is in compliance with the corresponding safety regulations.

In addition, the homepages 17 offer the possibility for an on-site diagnosis and also for remote diagnosis, which can be performed by connection to the World Wide Web (www). Maintenance, especially remote maintenance, may also be performed within the framework of the diagnosis. At least the WEB server 13 of the system control 10 is preferably connected to the World Wide Web via at least one additional interface 15.

The production system 1 may be controlled automatically via the system control 10 and the other connected controls 6, 7, 8, 9. The signal exchange between the system control 10 and the other intelligent application components 3 takes place via the WEB servers 13 and the data network 16 with the TCP/IP protocol. The control signals are converted at the transmitter into the TCP/IP protocol and correspondingly converted back into the control signals for the computer controls 14 of the intelligent applicant component 3. The transmission of the control signals in manual and automatic operation and the processing in the computer controls 14 take place at a speed necessary for the safe operation for the personnel and the devices. The respective states and functions of the intelligent application components 3 are displayed on the homepages 17 by means of browsers. The homepages 17 are polled via corresponding browsers.

The intelligent applicant components 3 with the WEB servers 13 belonging to them are standardized and prepared by their manufactures to the extent that they are integrated within the data network 16 and the WEB control system 2 extensively automatically during the installation according to the plug-and-play principle. The homepages 17 belonging to them are also standardized by the manufacturers and completely provided with operating instructions, spare parts lists, system description and other similar information, so that the installation and documentation effort for the design and for the operator of the production system 1 is minimized.

Various variants of the embodiment shown are possible. The data network 16 is designed as an internal network within the system in the exemplary embodiment being shown. However, a networking of the same type, extending beyond the production system 1, e.g., a system network, to which various production systems 1 located at the same site or at different sites are connected. Moreover, the above-mentioned connection to the World Wide Web may be present as well. The number, arrangement and design of the intelligent application components 3 shown and described in the exemplary embodiment may be varied as desired and they may deviate from the exemplary embodiment shown. Likewise, the design of the homepages 17 and the dynamic fields 18 may also be changed as desired. In the intelligent application components 3, the internal control of the device parts 26 of these components may also take place as an alternative in the conventional manner with a suitable bus system, e.g., a professional bus system or the like. While specific embodiments of the invention have been shown and described in detail to illustrate the application of the principles of the invention, it will be understood that the invention may be embodied otherwise without departing from such principles.

1. A process for controlling an industrial production system, the system comprising one or more intelligent application components, and at least one system control equipped with a WEB server having a webpage describing the system control according to Internet Protocol, the process comprising the steps of
sequentially controlling with the system control the intelligent application components with a WEB control system and a data network, wherein the intelligent application components are equipped with a WEB server each with a webpage describing a respective said intelligent application component according to the Internet Protocol.

2. A process in accordance with claim 1, wherein control parts of the intelligent application components control device parts belonging to them by a WEB control system and a data network wherein the device parts are equipped with an intelligence or with an intelligent interface and with a WEB server each with at least one webpage according to the Internet Protocol.

3. A process in accordance with claim 2, wherein all the system controls, and all of said control parts and said device parts of the intelligent application components of the industrial production system are connected to one another and communicate with one another by means of a common WEB control system and the data network.

4. An industrial production system for manufacturing components, the production system comprising:
one or more intelligent application components including one or more of a multiaxial robot, a welding device; a bonding device and a clamping device,
a system control with a WEB server with at least one homepage describing the system control according to Internet Protocol,
a WEB control system and a data network wherein the system control and the intelligent application components are connected in terms of control engineering by the WEB control system and the data network; and
an intelligent application component WEB server with at least one homepage according to the Internet Protocol, said system control sequentially controlling said intelligent application components.

5. A production system in accordance with claim 4, wherein the intelligent application components have a control part and a device part which are connected by the WEB control system and the data network in terms of control engineering, wherein the device part is equipped with an intelligence or with an intelligent interface and with the intelligent application component WEB server with the intelligent application component homepage.

6. A production system in accordance with claim 5, wherein the system control, and all of the control parts and device parts of the intelligent application components are connected to one another by the WEB control system and the data network as a common WEB control system

7. (Canceled)

8. A production system in accordance with claim 4, further comprising one or more display and operating devices with a browser for displaying and operating each intelligent application component homepage, the one or more display and operating devices with the browser being connected to the data network.

9. A production system in accordance with claim 4, wherein the data network is a Fast Ethernet network and the connected application components and said WEB servers have interfaces for the Transmission Control Protocol/Internet Protocol.

10. A production system in accordance with claim 4, wherein the intelligent application component WEB server has a plurality of hierarchically structured homepages.

11. A production system in accordance with claim 4, wherein the homepages of one or more of the intelligent application components WEB server are stored partially on other intelligent application component WEB servers.

12. A production system in accordance with claim 10, wherein the homepages of the intelligent application component WEB server have display and/or control elements for the corresponding application component.

13. (Canceled)

14. A production system in accordance with claim 8, wherein the data network extends beyond the production system or is connected to another data network of the same type, especially a system network or the World Wide Web, wherein the display and operating devices connected there and located outside the production system have access to the homepages of the intelligent application components located within the production system.

15. A production system in accordance with claim 4, wherein:
said system control sequentially sends control instructions to said application components for immediate and direct action of said application components.

16. An industrial production arrangement comprising:
a plurality of application components each having a control part and a device part where said control part includes a WEB server with a webpage,
a data network connecting each of said application components using Internet Protocol;
a system control unit connected to said data network using said Internet Protocol, said system control unit including a WEB browser reading, displaying and interacting with said webpages of said plurality of application components, said system control unit sequentially controlling said plurality of application components through said data network using said Internet Protocol.

17. An arrangement in accordance with claim 16, wherein:
said system control unit includes a WEB server with a webpage for said system control units;
each of said plurality of application components include a WEB browser reading, displaying and interacting with said webpages of said system control unit and other said application components.

18. Au arrangement in accordance with claim 16, wherein:
said device part of said application components includes a tool for physically processing a product of the industrial production arrangement;
said webpages of each of said plurality of application components provide status information of a respective tool of said application component and provide function links for controlling said tool of said respective application component.

19. (Canceled)

20. An arrangement in accordance with claim 17, wherein:
said webpages of each of said plurality of application components provide status information of a respective said application component and provide function links for controlling said respective application component;
said Internet Protocol is Transmission Control Protocol/internet Protocol (TCP/IP);
said webpages are in one of HTML or X format.

21. An arrangement in accordance with claim 16, wherein:
said device part manipulates a workpiece;
said control unit sequentially instructs said application components to perform immediate actions on the workpiece.

22. An arrangement in accordance with claim 21, wherein:
said control unit individually instructs said one application component to perform the immediate actions on the workpiece;
said control unit waits until completion of one immediate action before instructing said one application component to perform another immediate action.

23. An arrangement in accordance with claim 16, wherein:
said system control unit is a Programmable Logic Control.

24. An arrangement in accordance with claim 16, wherein:
said system control unit operates a sequence program to instruct said device part to manipulate a workpiece.

25. An arrangement in accordance with claim 16, wherein:
said system control unit performs control engineering of said application components.

26. An arrangement in accordance with claim 16, wherein:
said system control unit sends control commands directly to said application components for manipulation of a workpiece.

27. An arrangement in accordance with claim 26, wherein:
said control commands are time critical for immediate action of said application components.

28. An arrangement in accordance with claim 16, wherein:
each of said Web servers of said application components has an Internet Protocol address.

29. An arrangement in accordance with claim 16, wherein:
said web pages of said application components have status information of respective said application components.

30. An arrangement in accordance with claim 16, wherein:
said application components can be controlled through respective said Web pages.

31. An arrangement in accordance with claim 16, wherein:
said device parts include robots for handling and modifying vehicle parts.

32. An arrangement in accordance with claim 16, wherein:
said device parts include clamping tools and bonding tools.

33. An arrangement in accordance with claim 32, wherein:
said clamping tools include an intelligent component.

34. An arrangement in accordance with claim 16, wherein:
said system control unit and said control parts include special software modules, which are based on the Internet protocol and ensure exchange of control commands in application-related real time by ordering said control commands and grouping said control commands in order to expedite data traffic under the Internet protocol.
